(19) United States
(12) Patent Application Publication
(10) Pub. No.: US 2025/0345869 A1
(43) Pub. Date: Nov. 13, 2025

(54) DEVICE FOR KNIFE CUTTING OR SAWING OF WORKPIECES WITH MONITORING OF STRIP DAMAGE, METHOD FOR MONITORING THE CONDITION OF DAMAGE OF A BAND KNIFE OR BAND SAW

(71) Applicant: Spezialmaschinenfabrik, Freudenberg (DE)

(72) Inventors: Julian Brückner, Wilnsdorf (DE); Jan Horsthemke, Siegen (DE); Inal Rocky D´Costa, Düsseldorf (DE); Christoph Moisel, Köln (DE); Shubham Sharma, Siegen (DE); Peter Kraemer, Waldbüttelbrunn (DE); Wolfgang Richter, Netphen (DE); Andreas Nollen, Siegen (DE); Philipp Bertelmann, Unna (DE)

(21) Appl. No.: 19/067,364

(22) Filed: Feb. 28, 2025

(30) Foreign Application Priority Data
Mar. 1, 2024 (DE) 102024106030.1

(51) Int. Cl. B23D 59/00; B23Q 17/09

(52) U.S. Cl. CPC B23D 59/001; B23Q 17/0995

(57) ABSTRACT

The invention relates to a device for knife cutting or sawing workpieces, with an endless, circumferential band knife (26) or an endless, circumferential band saw, respectively, wherein the device (10) has at least one sensor (42a, 42b, 42c, 42d, 42e, 42f), wherein the at least one sensor (42a, 42b, 42c, 42d, 42e, 42f) acquires a measuring value representing the band damage and wherein the sensor (42a, 42b, 42c, 42d, 42e, 42f) is connected to at least one evaluation unit (44) and the measuring value representing the band damage is supplied to the evaluation unit (44) and wherein based on the measuring value, information about the damage state of the band knife (26) or of the band saw can be generated by means of the evaluation unit (44).

The invention relates to a device for knife cutting or sawing workpieces according to patent claim 1. The invention further relates to a method for monitoring the state of an endless circumferential band knife or respectively of an endless circumferential band saw according to claim 6, a computer program according to patent claim 10 and a retrofitting kit according to patent claim 11.

Knife cutting and sawing are processing methods of workpieces thereby, which are defined in accordance with DIN standards (e.g., DIN 8588 and DIN 8589-6). Knife cutting thereby refers to the cutting of a workpiece by means of at least one knife and sawing refers to the machining of a workpiece. In particular, smooth and toothed knives are used for knife cutting and saw blades with tooth interlocking are used for sawing.

Devices for knife cutting (also referred to as cutting machines) or devices for sawing, in particular for cutting or sawing foams or plastics, are well known from the prior art. Such devices are in particular known, which have an endless, circumferential band knife or an endless circumferential band saw, respectively. The band knife or the band saw, respectively, thereby continuously passes through a cutting region, in which a workpiece is supplied and cut. For this purpose, the band knife or the band saw, respectively, is generally guided and driven via several deflection rollers (also referred to as running wheels or, for cutting machines, as knife wheels) and forms a closed shape.

Such endless, circumferential band knives or band saws, respectively, are subject to a large variety of stresses thereby:

For example, such band knives or band saws, respectively, are subject to tensile loads, which are caused in that the band knife or the band saw, respectively, is tensioned to a defined band tension via a tensioning unit (e.g., a pneumatic cylinder), and is deflected while cutting or sawing the workpiece, respectively.

Band knives or band saws, respectively, are additionally subject to bending loads. As described above, a band knife or a band saw, respectively, it guided and deflected via deflection rollers during operation. This deflection leads to bending loads, which are defined by the diameter of the deflection rollers.

Especially band knives in certain devices for cutting workpieces are additionally subject to special loads. For cutting any 2D contours, the band knife is usually twisted by means of twisting units. The twisting of an endless band knife usually takes place between two bearing points on the deflection rollers, which are located on both sides of the cutting region, and twisting units corresponding thereto, wherein the remainder of the band knife is not twisted. The torsional load increases as a function of the angle of twist.

The service life of such endless, circumferential band knives or band saws as described above can be limited to below a hundred hours up to several hundreds of hours. At the end of the service life, the band knives or band saws, respectively, usually tear. The band knife or the band saw, respectively, typically tears during an ongoing process, in which the band knife or the band saw is located within the workpiece. This generally leads to the complete or partial destruction of the workpiece to be processed. Economic disadvantages result especially when expensive workpieces are destroyed or when, in the case of an automated process, which runs over night, e.g., this process is cancelled early due to a tear of the band knife or band saw, respectively, and the remainder of the production time passes without being utilized, or when the device is part of a production line and the entire line is halted with the standstill.

It is thus the underlying object of the invention to provide a device for knife cutting or sawing and a method, by means of which the use of the device can be improved, a plannable maintenance prior to a suddenly occurring knife tear is possible, the material waste of workpiece material is reduced as well as the general safety is increased. A computer program and a retrofitting kit are to further be provided, by means of which a method and an existing device with the above advantages is to be made possible.

According to the invention, the solution of the object takes place with the features of the independent claims. Further practical advantages and embodiments are described in connection with the dependent claims.

The invention relates to a device for knife cutting or sawing workpieces. The workpiece is in particular a workpiece made of foam or plastic. The device thereby has an endless, circumferential band knife or an endless, circumferential band saw. In this case, endless means that the band knife or the band saw, respectively, is a closed band, without defined beginning and defined end. The band knife or the band saw, respectively, circulates in one direction (clockwise or counterclockwise).

The device in particular has several deflection rollers, in particular at least two, preferably four or more, e.g., at least five or six deflection rollers. The deflection rollers are arranged spaced apart from one another and serve the purpose of guiding and bearing the band knife or the band saw, respectively. In the case of four deflection rollers, in particular the band knife or the band saw, respectively, spans a square (e.g., rectangular or trapezoidal) plane. It can additionally be provided that not all deflection rollers lie in one plane. In the case of at least one deflection roller, the latter is in particular a drive roller. The deflection rollers are in particular arranged so that a respective deflection roller is arranged laterally of a cutting region. In the case of a horizontal device, this can be on the left and right next to the cutting region, and in the case of a vertical device, above and below the cutting region. The cutting region is thereby that region, in which the workpiece is located and comes into contact with a cutting section of the band knife or of the band saw, respectively.

In particular at least one deflection roller is a tensioning roller. The tension roller is movably or slidably arranged, respectively, in order to exert a defined band tension on the band knife or the band saw, respectively. The displacement of the tensioning roller is realized in particular by means of an actuator, such as a pneumatic cylinder, a hydraulic cylinder, a coil spring, a disk spring assembly, a spindle and/or an electromechanical actuator.

The band knife rotates in particular at a speed of 3-30 m/s (in the case of knife cutting) or the band saw rotates at a speed of 50-100 m/s (in the case of sawing), respectively.

The band knife can be toothed (with or without serration) or untoothed.

The device is in particular suitable for cutting or sawing foams or plastics and in particular for cutting or sawing
polymer foams (such as PU, PE, EVA, PVC, PS, PP, PE),
foamed and/or porous materials, such as foam glass or structural materials (honeycomb grids),
rubber or rubber compound,
fiber and further composite materials (e.g., cork),
composite foam or recycled, shredded and then newly adhered foam,
elastic, soft solid materials made of PU,
brittle-hard materials, such as, e.g., insulating materials made of foam, rubber or plastic.

The workpiece in particular has a tensile strength of up to approximately 30 MPa and a density of up to 1400 kg/m³.

The device is in particular a contour cutting machine with a band knife. The band knife can be twisted about its longitudinal axis, in particular in sections, in particular in the cutting section. The band knife can in particular be twisted by at least ±270° and preferably by at least ±360° in the cutting section with respect to the remaining section of the band knife. The band knife is then subject to a torsion. The twisting is realized in particular by means of twisting units. One twisting unit is in each case located on the left and right side of the cutting region or above and below the cutting region, respectively. The twisting units twist the band knife in the region between the two deflection rollers laterally spanning the cutting region and the twisting units. The band knife is twisted in the region between the twisting units and adjacent tensioning rollers. The band knife is twisted in the cutting region and with respect to the bearing points on the deflection rollers. Viewed in the longitudinal direction of the band knife, at least one center mount for the band knife, which additionally guides the band knife in the cutting region and which can also have a twisting unit, can additionally also be arranged. The center holder is placed in particular in the center of the cutting region.

The device can be designed for vertically as well as for horizontally cutting or sawing. This means that the relative movement between the band knife or the band saw, respectively, in addition to the direction of rotation and the workpiece takes place in the vertical or in the horizontal direction. In response to the vertical cutting or sewing, in particular the band knife or the band saw, respectively, is guided through the workpiece from the top down along a vertical direction (z direction), in order to cut vertical 2D contours in a horizontal plane (x-y plane). In the case of a horizontal device, the band knife or the band saw, respectively, runs through the workpiece in a transverse direction (x direction), in order to cut horizontal 2D contours in a vertical plane (y-z plane). The feed of the workpiece is in particular 1-100 m/min.

According to the invention, the device has at least one sensor, which detects a measuring value representing the band damage. Separate sensors, which are arranged on the device as well as sensors already integrated into the device and/or sensors, which are part of the machine control, are to be understood as sensors here. The latter sensors in particular also serve the purpose of reading out other parameters, which are relevant for the machine control.

The at least one sensor is connected to an evaluation unit and the measuring value representing the band damage is supplied to the evaluation unit. The evaluation unit is thereby in particular part of the device or of the sensor but can be arranged locally separated from the device or the sensor. The evaluation unit can in particular be a server or microcontroller or a Field Programmable Gate Array (FPGA), which is wire-connected or wirelessly connected to the sensor. Based on the measuring value, information about the damage state of the band knife or of the band saw, respectively, can be generated by means of the evaluation unit. As described in detail below, such information can be a forecasted remaining service life of the band knife or of the band saw, respectively. Alternatively or additionally, the information can be a recommendation with regard to an optimization of the cutting or sawing process, respectively, and/or a warning that the current cutting or sawing conditions, respectively, or cutting or sawing parameters, respectively, put heavy stress on the band knife or the band saw, respectively.

As described above, tearing can occur in the case of such endless, circumferential band knives or band saws, respectively, in particular due to friction or torsion, in particular also as described above at points in time, at which the production is significantly impacted. By monitoring the state of the band knife or the band saw, respectively, via a measuring value representing the band damage and the possibility resulting therefrom of making a statement about the state of the band knife, a quantitative possibility is provided, which makes it possible that corresponding measures can be taken in due time before the band knife or the band saw, respectively, tears. The band knife or the band saw, respectively, can thus be exchanged, e.g., before a new workpiece is processed, or the parameters of a cutting program or sawing program can be adapted accordingly, in particular so that the processing of the workpiece, which is currently present in the process, can still be concluded without the tear. The service life of the band knife or of the band saw, respectively, can be utilized optimally, without the band knife or the band saw, respectively, being unnecessarily exchanged much too soon. The process safety is increased because the band knife or the band saw, respectively, does not tear unexpectedly during cutting and, e.g., a removal of sharp fragments from the device does not become necessary.

In a practical embodiment, the at least one sensor directly or indirectly measures a displacement path of at least one tensioning roller. The tensioning rollers serves the purpose of tensioning the band knife or the band saw, respectively, to a defined band tension. The tensioning roller is in particular a deflection roller for guiding and storing the band knife or the band saw, respectively.

The at least one sensor can in particular directly or indirectly measure an acting force of a tensioning roller. An indirect measurement can take place, for example, via the air pressure of a pneumatic cylinder or the force can be determined by means of a strain gauge assembled on the tensioning roller.

The above-described sensor for measuring the displacement path of the tensioning roller is in particular a distance meter, in particular a laser distance meter, a cable sensor or a linear-potentiometric or magnetic tape or magnetoresistive or incremental optical (“glass scale”) position sensor.

In a further practical embodiment, the at least one sensor can be a temperature sensor for indirectly or directly detecting the temperature of the band knife or of the band saw, respectively. The temperature is in particular detected in a contact-free manner. The temperature sensor is in particular arranged in such a way that it detects the temperature of the band knife or of the band saw itself, respectively. Advantageously, it is a pyrometer, in particular a laser pyrometer. Alternatively or additionally, the temperature of the band knife or of the band saw, respectively, can be indirectly detected in that the temperature in the surrounding area of the band knife or of the band saw, respectively, is measured. In particular a PT100 sensor or thermocouple can be provided as temperature sensor for measuring the ambient temperature. In particular, a first temperature sensor for measuring the temperature of the band knife or of the band saw, respectively, and a second temperature sensor for measuring the ambient temperature are provided, wherein in particular the difference between the temperature of the band knife or of the band saw, respectively, and the surrounding area serves as measuring value.

When detecting measuring values, which represent the band damage, it is challenging that the band knife or the band saw, respectively, moves constantly, namely rotates in the direction of rotation and is optionally also twisted. The band knife or the band saw, respectively, is additionally located mostly within the workpiece with the stressed cutting section. A measurement on a separate component and not directly on the band knife or the band saw, respectively, is thus advantageous.

Additionally or alternatively, the at least one sensor is an acceleration sensor for measuring vibrations caused by the band knife or the band saw, respectively. The at least one acceleration sensor is in particular arranged on an element, which is in close contact with the band knife or the band saw, respectively. In particular, an acceleration sensor can be arranged on a mount of a deflection roller or on a mount of the tensioning roller (=tensioning carriage), respectively, and/or on the center holder and/or a twisting unit. A triaxial acceleration sensor is in particular used as acceleration sensor. For example, the frequency and amplitude of the vibrations or accelerations, respectively, thereby represents a measuring value, which represents the band damage.

In further practical embodiments, the band speed can be detected as a measuring value, which represents the band damage, e.g., via the rotational speed of the deflection rollers, which can be gathered, e.g., from the control of the device. For this purpose, for example an LSV (Laser Surface Velocitymeter), an incremental rotary encoder or rotation angle sensor (e.g., based on the Hall effect or an optical, inductive, electromagnetic or eddy current measuring principle) can serve as sensor.

The torsion angle can furthermore be detected as a measuring value, which represents the band damage, e.g., via the tilting of the twisting units, whereby this torsion angle is measured, e.g., via an incremental rotary encoder or rotation angle sensor (e.g., based on the Hall effect or an optical, inductive, electromagnetic or eddy current measuring principle).

Acoustic emission sensors are also conceivable, by means of which sound waves are detectable. Such sound waves can be caused, e.g., by the interaction between the band knife or the band saw, respectively, and further components of the device or by the material changes in the band knife or in the band saw itself, respectively.

Additionally or supplementarily, electrical or fiber-optical strain gauges or piezo-electrical or piezo-resistive sensors, respectively, can be used for measuring the interaction between components of the machine, e.g., of the tensioning roller, and the band knife or the band saw, respectively. These are arranged at locations within the device, where stresses/expansions/deformations and/or vibrations occur, which correlate with the state of the band knife or of the band saw, respectively, e.g., at the force introduction point between a tensioning roller and an actuator or at an axle or axle suspension, respectively, of at least one deflection and/or drive roller or at the arm of at least one center holder.

Sensors, which are already provided for the machine control, can also be used, which measure, e.g., the motor current or the torque of the drive roller, the motor current or the torque of at least one drive of a twisting unit, the motor current or the torque of at least one drive of a table for storing the workpiece, the air pressure of a pneumatic cylinder or the motor current of an electrical linear cylinder on a tensioning roller, respectively.

The at least one sensor can furthermore be a digital camera with an automated image processing connected downstream for detecting tears and/or other geometric and optical changes of the band knife or of the band saw, respectively.

The at least one sensor can furthermore be an eddy current sensor for detecting tears and/or geometrical changes of the band knife or of the band saw, respectively.

The at least one sensor can furthermore be an eddy current sensor or an ultrasonic sensor for measuring vibrations of the band knife or of the band saw, respectively.

In addition to the sensors, the evaluation unit is in particular also connected to an input device, in particular for inputting further parameters with respect to the material to be cut (such as density, for instance), the material of the band knife or of the band saw, respectively, the most recently performed change of the band knife or of the band saw, respectively, a tear, the diameter of the deflection rollers and/or the further characteristics of the band knife or of the band saw, respectively.

In particular, only one of the above-described sensors can be provided. Alternatively, several sensors of an identical or different type are provided, by means of which different measuring values, which represent the band damage, are determined and are used for the forecast.

In particular, measuring values are permanently determined by means of the one or the several sensors, in order to currently compile information about the damage state of the band knife (e.g. a current forecast of the service life of the band knife) in each case.

In a further practical embodiment, the device has an output unit, which outputs the generated information. For example, the output unit can output a remaining service life, a recommendation with regard to an optimization of the cutting or sawing process, respectively, and/or a warning. The output unit can in particular be a display, by means of which, e.g., the remaining service life can be displayed as number in hours or minutes or seconds. The output unit can also be present on a separate device and the information is transmitted therein.

The output unit can also be a signaling means, which in particular has at least one individual light source and which can display different colors. The remaining service life of the band knife or of the band saw, respectively, can be visualized by means of a color coding. The signaling means can thus light up in green when the service life still corresponds to more than a previously defined number of hours, and can light up in red when the service life falls below a specified minimum service life or the run time, respectively, of a cutting or sawing program, respectively. The operating state of the device can also be output by means of color code. As an example, the signaling means can light up in green if no warning is present, in orange if a warning was generated and in red if the device stands still.

The output unit can also be a signaling means, which in particular has at least one acoustic element, e.g., a loudspeaker or an electromagnetic fanfare, and which can generate a tone or different tones. A critical operating state of the device can be pointed out by means of a signal tone or different signal tones.

The invention also relates to a method for monitoring the damage state of an endless, circumferential band knife or of an endless, circumferential band saw, respectively, wherein at least one measuring value representing the band damage is detected and information about the damage state of the band knife or of the band saw, respectively, is generated on the basis of the at least one measuring value. In particular workpieces made of foam or plastic are processed with the band knife or the band saw, respectively.

The monitoring takes place in particular in a separate test run before and/or during and/or after a cutting operation. The test run can in particular take place under certain, settable and reproducible conditions or machine parameters, respectively, e.g., also at reduced band speed or statically. These parameters can also cause a targeted stress, e.g., torsion and/or band tension. A test run can in particular also be used to allow specific physical effects (e.g., a targeted vibration or ultrasonic excitation) on the band knife or the band saw, respectively.

The monitoring preferably takes place during the ongoing production operation of the device. However, a possible separate test run can also be triggered after a cutting or sawing process, respectively, to validate the forecast from the ongoing production process.

As already described above, it is made possible in different ways to optimize the workload and utilization of the device by monitoring the band knife or the band saw, respectively, followed by a quantitative evaluation.

The above-described information is generated in particular by means of a comparison between current data and the data of already sorted out and/or torn band knives or band saws, respectively. In particular a machine-learning model is trained thereby. In particular previously detected measuring values of already used band knives or of band saws, respectively, are used as training data and the reached service life of the band knife or of the band saw, respectively, which corresponds thereto. Drive data, parameters of the cutting or sawing program, respectively, as well as material information of the workpiece or of the band knife or of the band saw, respectively, can additionally also be used as training data.

Every new life cycle of a band knife or of a band saw, respectively, is then used to supplement the training data set. The course of the measuring value or of the several measuring values, respectively, during the service life of the band knife or of the band saw, respectively, is used as training data set and is updated in each case. The current information is then generated by means of the algorithm on the basis of current measuring values determined by the at least one sensor. The measuring values are in particular recorded continuously and statistical variables of the measuring values are formed subsequently (e.g., average value, median, skewness, RMS value) for a defined past interval (e.g., 10 s). These statistical values can then subsequently be used for training the model or for calculating the remaining service life, respectively. All measuring values are preferably combined into one parameter and that data set from the training data, which is most similar to the current parameter, is in each case used for generating the information, and in particular for forecasting the remaining service life on the basis of a similarity model.

In particular, the remaining service life of the band knife or of the band saw, respectively, is forecast on the basis of the at least one measuring value. Due to a respective currently created forecast of the remaining service life, a decision can be made, e.g., on the basis of data, whether a new process for cutting or sawing a workpiece is to still be started with the available, installed band knife or band saw, respectively (this is the case if the process time is <remaining service life) or whether the band knife or the band saw, respectively, is to be exchanged prior to starting the process (process time>remaining service life). The cutting or sawing program, respectively, can be selected in particular based on the residual remaining service life of the band knife or of the band saw, respectively, and the cutting or sawing parameters, respectively, can optionally be adapted accordingly.

The respective currently determined remaining service life of the band knife or of the band saw, respectively, is output in particular on an output unit. The concrete time can thus also be specified, e.g., on a display (e.g., “currently forecast remaining service life is still 5 hours”) or it can be signaled by means of a signal light whether the forecast remaining service life lies above or below a defined remaining service life.

In particular, the forecast is constantly updated. When an increased, unexpected damage to the band knife or the band saw, respectively, is measured, the forecast service life can also decrease more quickly than originally assumed.

In addition or supplementary to forecasting the remaining service life, a suggestion with regard to an optimization of the cutting or sawing process, respectively, can be output as information. The generated information can in particular be considered by the machine control of the device (stress-optimized machine regulation). For example, the rotational speed can be increased and/or the feed speed of the workpiece can be reduced. If a new cutting or sawing process, respectively, is to be started, it is checked in particular automatically whether this process can be brought to an end with the existing band knife or the existing band saw, respectively. The duration of the cutting or sawing process, respectively, is compared thereby to the forecast remaining service life of the band knife or of the band saw, respectively. If the remaining service life is less than the duration of the cutting or sawing program, respectively, a corresponding notification is output.

Alternatively or supplementarily, a warning can be output in the case of excessive damage to the band knife or the band saw, respectively, e.g., when it is determined on the basis of the current measuring values that the damage to the band knife or the band saw, respectively, is currently particularly high and the forecast service life decreases more quickly than usual or more quickly than a defined maximum value.

A warning has to in particular be acknowledged by a person, e.g., if the remaining service life is less than the duration of the cutting or sawing program, respectively. It can also be provided that the start of a cutting program is not permitted if the forecast service life is less than the duration planned for the cutting or sawing program, respectively. This ensures that the device is started only under optimal conditions.

The invention further relates to a computer program including machine-readable instructions, which, when they are executed on one or several computers, cause the computer or the computers to carry out a method as described above. In particular, it is a computer program, which interacts with a machine control of a device. The computer program can in particular be integrated retrospectively, as update, into the machine control software. Microcontrollers, controls (SPS) and/or

FPGA circuits are to also be understood as computer.

The invention also relates to a retrofitting kit for a device for cutting or sawing workpieces, in particular made of foam or plastic, with an endless, circumferential band knife or an endless, circumferential band saw, respectively. The retrofitting kit comprises at least one sensor for the arrangement on the device, wherein the at least one sensor is designed for measuring a measuring value representing the band stress.

The various sensors are described above in connection with the device. The at least one sensor in each case has means for assembling it on the system.

The retrofitting kit in particular also comprises a computer program according to the above description, wherein the measuring values of the sensors can be analyzed by means of the computer program and a forecast of the remaining service life is made accordingly.

Further practical embodiments and advantages are described in combination with the figures, in which:

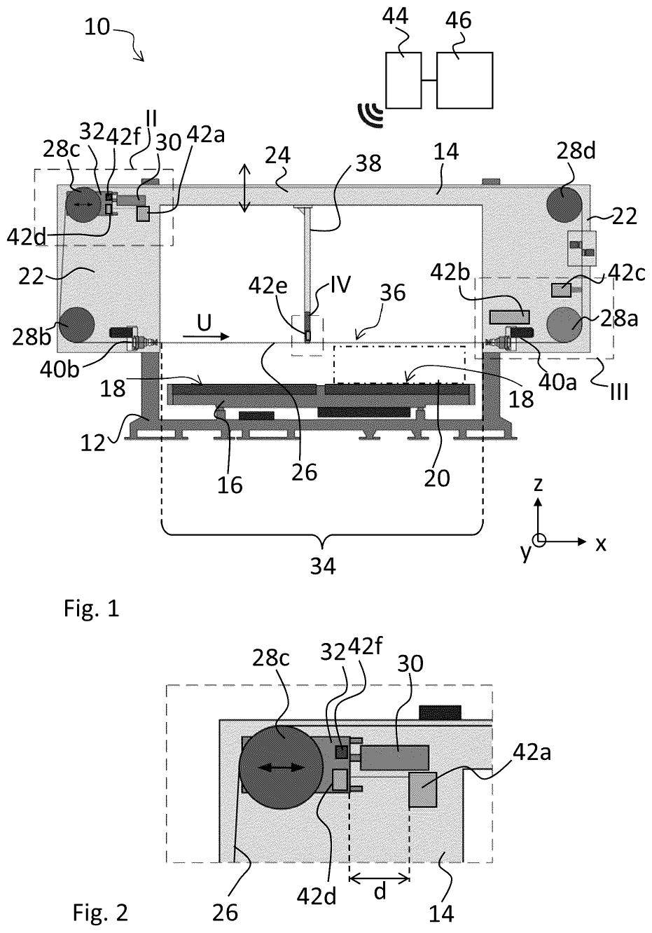

FIG. 1 shows a horizontal contour cutting machine in a schematic illustration in a view from the front,

FIG. 2 shows the region from FIG. 1, which is identified with II, in an enlarged view

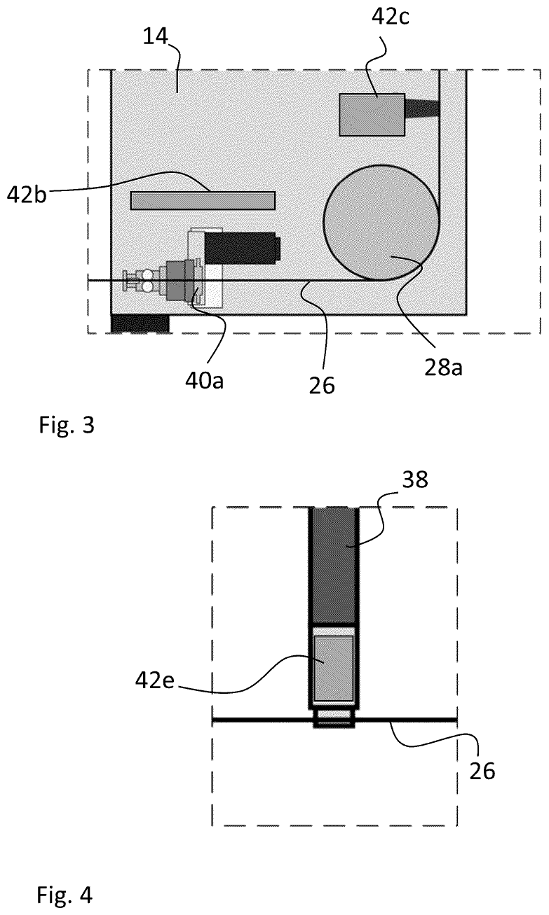

FIG. 3 shows the region from FIG. 1, which is identified with III, in an enlarged view,

FIG. 4 sows the region from FIG. 1, which is identified with IV, in an enlarged view,

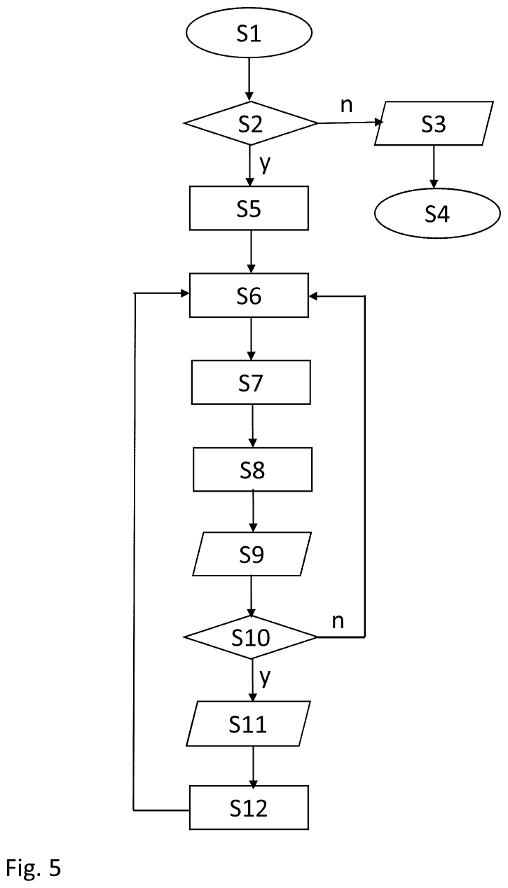

FIG. 5 shows a flowchart of a method according to a first embodiment.

A device for knife cutting or sawing and, specifically here, a horizontal contour cutting machine 10 is shown in a schematic illustration in FIG. 1.

The cutting machine 10 has a machine stand 12 and a frame 14 arranged thereon. The machine stand 12 serves the purpose of setting up the cutting machine 10 on the floor and of receiving a table 16, which can be moved in the y direction. In the present case, the table 16 has two support surfaces 18 for one workpiece 20 each. In the present case, a workpiece 20 (only illustrated schematically here) is arranged on a support surface 18 of the table 16.

In the present case, the frame 14 is formed by two side parts 22 and an upper frame part 24. The frame 14 forms a housing for an endless, circumferential band knife 26. In the present case, the band knife 26 is spanned to form a rectangular plane (x-z plane) via four deflection rollers 28a, 28b, 28c, 28d, wherein the deflection rollers 28a, 28b, 28c, 28d are in each case located in the corners of the rectangular plane. The band knife 26 rotates around the four deflection rollers 28a, 28b, 28c, 28d in the direction of rotation (along the arrow U here). The deflection rollers 28a, 28b, 28c, 28d serve the purpose of guiding the band knife 26.

The four deflection rollers 28a, 28b, 28c, 28d are arranged within the frame 14 and also a majority of the circumferential band knife 26. A tensioning roller 28a is the drive roller, which serves the purpose of driving the band knife 26 in the direction of rotation U.

In order to ensure a sufficient band tension of the band knife 26, the deflection roller 28c is a tensioning roller, which is connected to a pneumatic cylinder 30. Together with a tensioning carriage 32, the tensioning roller 28c is supported on the frame 14 so as to be capable of being shifted in the transverse direction (x direction).

A cutting region 34 is formed between the first deflection roller 28a and the second deflection roller 28b. A cutting section 36 of the band knife 26, which runs outside of the frame 14 and in which the band knife 26 extends in the transverse direction (x direction) of the cutting machine 10, is located in the cutting region 34. The workpiece 20 is supplied in the cutting region 34 and is cut here by the band knife 26. A center holder 38, which extends perpendicularly downwards (in the z direction) from the upper frame element 24 of the frame 14, is arranged centrally of the cutting region 34. The center holder 38 serves the purpose of guiding and stabilizing the cutting section 36 of the band knife 26 in the cutting region 34.

The cutting machine 10 at hand is a horizontal cutting machine, wherein the frame 14, together with band knife 26, can be displaced in the vertical direction (z direction) and 2D contours are cut into the workpiece 20 in the y-z plane.

In order to also be able to cut oblique contours, the band knife 26 can be twisted in the cutting section 36. For this purpose, the band knife 26 can be twisted via twisting units 40a, 40b. The twisting units 40a, 40b are in each case arranged laterally of the cutting region 34 and twist the band knife 26 about the longitudinal axis. A twisting unit can additionally be arranged (not shown) on the center holder 38. The twisting units 40a, 40b are in each case synchronized and simultaneously twist the band knife 26 about the same angle of twist. The torsion of the band knife 26 takes place between the lateral twisting units 40a, 40b and the deflection rollers 28a, 28b adjacent thereto. The band knife 26 runs in a non-twisted manner or so as not to be twisted, respectively, between the twisting units 40a, 40b in the cutting region 26.

To check the state of the band knife 26, the cutting machine 10 has, according to the present exemplary embodiment, several sensors 42a, 42b, 42c, 42d, 42e, 42f, which in each case detect the measuring values representing the band damage to the band knife 26.

Here, a first sensor 42a is a distance sensor for measuring the displacement of the tensioning roller 28c. This is shown in detail in FIG. 2. Here, the tensioning roller 28c itself can be displaced in the x direction by means of the pneumatic cylinder 30. A defined tensioning force is thereby exerted on the circumferential band knife 26 in each case. The farther the tensioning roller 28c is deflected outwards-thus to the left in the x direction in FIG. 2—the stronger the band knife 26 has already lengthened. The shifting of the tensioning roller 28c is measured by means of the distance sensor 42a, which is arranged on the frame 14 in a stationary manner. Concretely, the distance d between the tensioning carriage 32, which can be displaced by means of the tensioning roller 28c, and the distance sensor 42a is measured.

A second sensor 42b is a temperature sensor for measuring the ambient temperature in the vicinity of the band knife 26 (see FIG. 3). The temperature of the band knife 26 is indirectly determined by means of the temperature sensor 42b. In the shown embodiment, the temperature sensor 42b is arranged in the surrounding area of the drive roller 28a.

A third sensor 42c is likewise a temperature sensor, which directly measures the temperature of the band knife 26 (see FIG. 3). This is a laser pyrometer, wherein a laser beam is directed at the band knife 26. In the shown embodiment, the third sensor 42c is arranged directly adjacent to the drive roller 28a.

A fourth sensor 42d and a fifth sensor 42e are acceleration sensors. The fourth sensor 42d is an acceleration sensor, which is arranged on the tensioning carriage 32 of the tensioning roller 28c, which can be shifted together with the tensioning roller 28c (see FIG. 2). The band knife 26 is in close contact with the tensioning roller 28c and transmits vibrations to the tensioning roller 28c and the tensioning carriage 32 thereof. These vibrations are detected by the acceleration sensor 42d. The acceleration sensor 42d measures the acceleration of the tensioning carriage 32 in all three spatial directions.

The fifth sensor 42e is arranged on the center holder 38 and measures the vibrations or accelerations, respectively, which are transmitted to the center holder 38 by means of the band knife 26. The acceleration sensor 42e likewise measures the acceleration in all three spatial directions.

A sixth sensor is a force sensor 42f, which directly or indirectly measures the acting force between the pneumatic cylinder 30 and the tensioning carriage 32 of the tensioning roller 28c in the direction of the pneumatic cylinder 30. In addition to the currently acting tensioning force, said sensor can also detect small changes of the force, which change quickly over time, due to transmitted vibrations.

The measuring values, which are determined by the respective sensors 42a, 42b, 42c, 42d, 42e, 42f and which represent the band damage, are transferred to an evaluation unit 44. In the shown embodiment, the communication between the sensors 42a, 42b, 42c, 42d, 42e, 42f and the evaluation unit 44 takes place wirelessly. The information generated by the evaluation unit 44, such as, for example, a forecast remaining service life of the band knife 26, is then displayed on an output unit 46.

A method for checking the damage state of a band knife 26 is further illustrated in FIG. 5.

The method is started with step S1.

After starting the method in step S1, it is checked in step S2 if the remaining service life of the band knife 26 is greater than the duration of the started cutting program.

If it is determined in step S2 that the determined remaining service life of the band knife 26 is less than the duration of the cutting program (n) to be started, the cutting program is initially not started and a warning is output in step S4. The method then ends in step S4. Instead of allowing the method to end, it can also be provided that the cutting parameters are adapted automatically or manually, so that the band knife 26 is conserved and the cutting program can still be executed or an operator clicks “ignore”.

If it is determined in step S2 that the determined remaining service life of the band knife 26 is greater than the duration of the cutting program (y=yes), the cutting program is started in step S5.

For the duration of the cutting program, a measuring value representing the band damage to the band knife 26 is detected by at least one sensor 42a, 42b, 42c, 42d, 42e, 42f in step S6 and is transferred to the evaluation unit 44 in step S7.

In step S8, the evaluation unit 44 generates information with respect to the damage state of the band knife 26 from the measuring value or the several measuring values, respectively. The information is generated by means of a trained machine-learning algorithm on the basis of the supplied measuring values. Here, the information is a remaining service life of the band knife 26.

In step S9, the remaining service life is transmitted to the output unit 46 and is output on the output unit 46.

After step S9, it is additionally checked in step S10 whether the current stress of the band knife 26 is particularly strong, if yes (y), a warning it output in step S11 and the parameters of the cutting process are additionally adapted in step S12. The method is subsequently continued with step S6.

If it is determined in step S10 that the stress of the band knife 26 is not greater than planned (n), the method is continued with step S6.

### LIST OF REFERENCE NUMERALS

10 device for knife cutting or sawing (cutting machine)
12 machine stand
14 frame
16 table
18 support surface
20 workpiece
22 side part
24 upper frame part
26 band knife
28a deflection roller, tensioning roller
28b deflection roller
28c deflection roller, drive roller
28d deflection roller
30 pneumatic cylinder
32 tensioning carriage
34 cutting region
36 cutting section
38 center mount
40a first twisting unit
40b second twisting unit
42a sensor, distance sensor
42b sensor, temperature sensor
42c sensor, temperature sensor
42d sensor, acceleration sensor
42e sensor, acceleration sensor
42f sensor, force sensor
44 evaluation unit
46 output unit
U direction of rotation
d distance mount tensioning roller to distance sensor

1. A device for knife cutting or sawing workpieces, with an endless, circumferential band knife (26) or an endless, circumferential band saw, respectively, wherein the device (10) has at least one sensor (42a, 42b, 42c, 42d, 42e, 42f), wherein the at least one sensor (42a, 42b, 42c, 42d, 42e, 42f) acquires a measuring value representing a band damage and wherein the at least one sensor (42a, 42b, 42c, 42d, 42e, 42f) is connected to at least one evaluation unit (44) and the measuring value representing the band damage is supplied to the at least one evaluation unit (44) and wherein based on the measuring value, information about a damage state of the endless, circumferential band knife (26) or of the endless, circumferential band saw is generated by means of the at least one evaluation unit (44).

2. The device according to claim 1,
characterized in that the at least one sensor (42a) directly or indirectly measures a displacement path of a tensioning roller (28c), wherein the endless, circumferential band knife (26) or the endless, circumferential band saw, respectively, is tensioned to a defined band tension by means of the tensioning roller (28c).

3. The device according to claim 1,
characterized in that the at least one sensor (42f) directly or indirectly measures an acting force of a tensioning roller (28c), wherein the endless, circumferential band knife (26) or the endless, circumferential band saw, respectively, is tensioned to a defined band tension by means of the tensioning roller (28c).

4. The device according to claim 1,
characterized in that the at least one sensor is a temperature sensor (42b, 42c), for indirectly or directly detecting a temperature of the endless, circumferential band knife (26) or of the endless, circumferential band saw, respectively.

5. The device according to claim 1,
characterized in that the at least one sensor is an acceleration sensor (42d, 42e), for measuring vibrations caused by the endless, circumferential band knife (26) or the endless, circumferential band saw, respectively.

6. A method for monitoring a damage state of an endless, circumferential band knife (26) or of an endless circumferential band saw, respectively, wherein at least one measuring value representing band damage is detected and information about the damage state of the endless, circumferential band knife (26) or of the endless, circumferential band saw, respectively, is generated on the basis of the at least one measuring value.

7. The method according to claim 6,
characterized in that the information about the damage state is generated among others by means of a machine-learning algorithm.

8. The method according to claim 6,
characterized in that a remaining service life of the endless, circumferential band knife (26) or of the endless, circumferential band saw is generated as the information about the damage state.

9. The method according to claim 6,
characterized in that a recommendation is issued with regard to an optimization of a cutting or sawing process, respectively.

10. A computer program, including machine-readable instructions,
which, when they are executed on one or several computers, cause the computer or the computers to carry out a method comprising:
monitoring a damage state of an endless, circumferential band knife (26) or of an endless circumferential band saw, respectively, wherein at least one measuring value representing band damage is detected and information about the damage state of the endless, circumferential band knife (26) or of the endless, circumferential band saw, respectively, is generated on the basis of the at least one measuring value.

11. (canceled)

12. The computer program of claim 10, characterized in that the information about the damage state is generated among others by means of a machine-learning algorithm.

13. The computer program of claim 10, characterized in that a remaining service life of the endless, circumferential band knife (26) or of the endless, circumferential band saw is generated as the information about the damage state.

14. The computer program of claim 10, characterized in that a recommendation is issued with regard to an optimization of a cutting or sawing process, respectively.
